(19) United States
(12) Patent Application Publication
(10) Pub. No.: US 2026/0195803 A1
(43) Pub. Date: Jul. 9, 2026

(54) SYSTEM AND METHOD FOR A BUNDLED MULTIPLE-ITEM PURCHASE OFFER FEATURE WITH USER-TO-USER TRADING OPTION FOR AN ECOMMERCE MARKETPLACE

(71) Applicant: BLADEBINGE, Woodstock, GA (US)

(72) Inventors: David Scotland STEPHENSON, Woodstock, GA (US); Kenneth Eric WILLIAMS, Woodstock, GA (US)

(73) Assignee: BLADEBINGE, Woodstock, GA (US)

(21) Appl. No.: 19/409,390

(22) Filed: Dec. 4, 2025

Related U.S. Application Data
(60) Provisional application No. 63/742,036, filed on Jan. 6, 2025.

(51) Int. Cl. G06Q 30/0601; G06Q 10/0833; G06Q 30/0283

(52) U.S. Cl. CPC G06Q 30/0641; G06Q 10/0833; G06Q 30/0283; G06Q 30/0631

(57) ABSTRACT

A system, method, and computer program product for managing bundled multiple-item purchase offers with an optional user-to-user trading mechanism. A local user may select one or more items from a remote user for purchase and optionally bundle additional items from the remote user in the proposed transaction. The local user may also offer one or more of their own items as a trade for all or part of the proposed purchase. The system facilitates negotiation of offers and counteroffers between the local and remote users and tracks associated settlement and inventory adjustments.

### CROSS-REFERENCE TO RELATED APPLICATIONS

This application claims the benefit of U.S. Provisional Application No. 63/742,036, filed on Jan. 6, 2025, the entire disclosure of which is hereby incorporated by reference.

### BACKGROUND

Conventional e-commerce marketplace orders share common concepts of orders, shipments, and items. These concepts maintain the roles of a buyer and seller and the domain relationship therebetween. A buyer purchases an item from a seller, resulting in a created order and the creation of shipments. Payments are exchanged and shipments are sent to the buyer from the seller. However, additional domain model concepts may be desired.

### SUMMARY

According to at least one exemplary embodiment, a system, method, and computer program product for bundled multiple-item offers with a user-to-user trading option is disclosed. Users may have items for sale on an e-commerce marketplace. A first user may select items from a second user for purchase and may bundle additional for-sale items of the second user in the proposed purchase. The first user may offer for-sale items of the first user as a trade for all or part of the proposed purchase. Offers and counteroffers for the bundle and the trade may be negotiated between the first user and the second user.

According to at least one exemplary embodiment, a Purchase Offer Financial Settlement model is disclosed. The model may present an online application interaction pattern which takes place between two distinct parties in an e-commerce marketplace. Both parties may be existing sellers on a peer-to-peer e-commerce marketplace, each seller having active items for sale.

The model can facilitate settling transactions and bypassing conventional settlement. The model can include: 1) an order for a buyer to buy a seller's items; and 2) an optional trade order for the seller to buy the buyer's items.

### BRIEF DESCRIPTION OF THE FIGURES

Advantages of embodiments of the present invention will be apparent from the following detailed description of the exemplary embodiments. The following detailed description should be considered in conjunction with the accompanying figures in which:

FIG. 1 is a simplified flowchart of an exemplary system for handling bundled multiple-item purchase offers and user-to-user trading in a marketplace application

FIG. 2 is a diagram of an exemplary embodiment of an e-commerce marketplace.

FIG. 3 shows a flowchart for an exemplary marketplace user interface node, showing creation of a trade offer by the local user and acceptance of the trade offer by the remote user.

FIG. 4 shows a flowchart for an exemplary marketplace user interface node, showing completion of a bundle and trade offer for both the local user and the remote user, including checkout and payout for the transaction.

FIG. 5 illustrates an exemplary feature enablement interface for a marketplace, showing options to enable offers and trade offers.

FIG. 6 illustrates an exemplary “make an offer” interface.

FIG. 7 illustrates an exemplary “create a bundle” interface.

FIG. 8 illustrates an exemplary “offer a trade” interface.

FIG. 9 illustrates an exemplary “My Offers” interface.

FIG. 10 illustrates an exemplary “accept offer confirmation” interface.

FIG. 11 illustrates an exemplary post-acceptance interface for a seller.

FIG. 12 illustrates an exemplary post-acceptance interface for a buyer.

### DETAILED DESCRIPTION

Aspects of the invention are disclosed in the following description and related drawings directed to specific embodiments of the invention. Those skilled in the art will recognize that alternate embodiments may be devised without departing from the spirit or the scope of the claims. Additionally, well-known elements of exemplary embodiments of the invention will not be described in detail or will be omitted so as not to obscure the relevant details of the invention. Further, to facilitate an understanding of the description discussion of several terms used herein follows.

As used herein, the word “exemplary” means “serving as an example, instance or illustration.” The embodiments described herein are not limiting, but rather are exemplary only. It should be understood that the described embodiment are not necessarily to be construed as preferred or advantageous over other embodiments. Moreover, the terms “embodiments of the invention”, “embodiments” or “invention” do not require that all embodiments of the invention include the discussed feature, advantage or mode of operation.

Further, many of the embodiments described herein may be described in terms of sequences of actions to be performed by, for example, elements of a computing device. It should be recognized by those skilled in the art that the various sequence of actions described herein can be performed by specific circuits (e.g., application specific integrated circuits (ASICs)) and/or by program instructions executed by at least one processor. Additionally, the sequence of actions described herein can be embodied entirely within any form of non-transitory computer-readable storage medium such that execution of the sequence of actions enables the processor to perform the functionality described herein. Thus, the various aspects of the present invention may be embodied in a number of different forms, all of which have been contemplated to be within the scope of the claimed subject matter. In addition, for each of the embodiments described herein, the corresponding form of any such embodiments may be described herein as, for example, “a computer configured to” perform the described action.

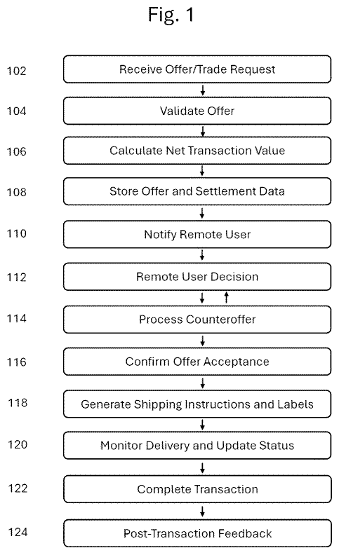

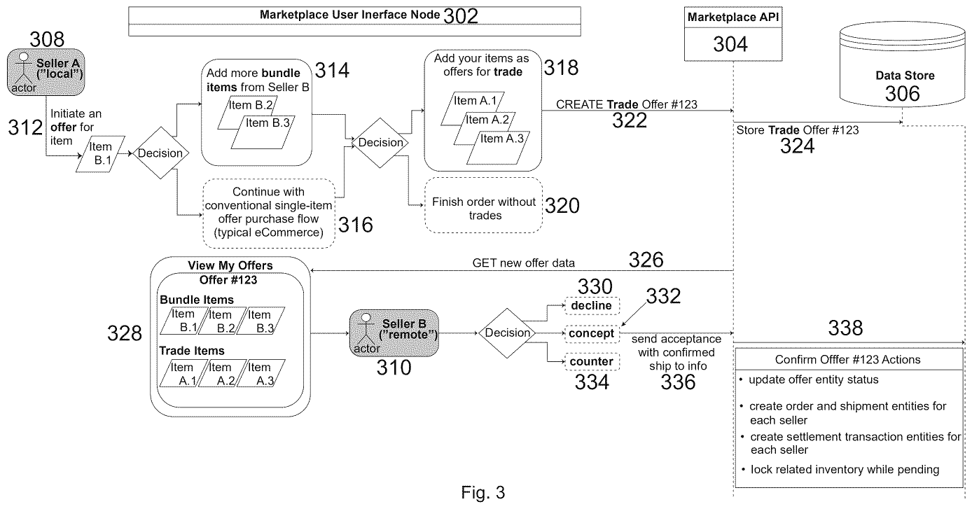

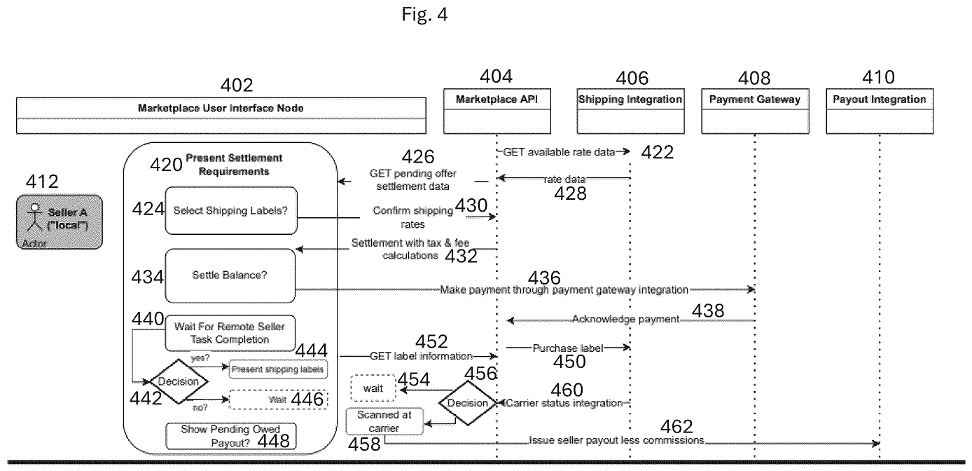

According to at least one exemplary embodiment, systems and methods for purchase offer settlement are disclosed. The system and method may facilitate interactions between two distinct parties in an e-commerce marketplace. FIG. 1 shows a flowchart that illustrates a high-level process for handling bundled purchase offers and user-to-user trading according to an exemplary embodiment. In step 102, the system may receive a user-initiated offer or trade. In step 104, the system may validate the offer for completeness, eligibility, and compliance with marketplace rules. In step 106, the system may calculate the net transaction value, including, for example, bundled items, trade items, fees, and discounts. In step 108, offer and settlement data may be stored in the system database. In step 110, notifications may be generated for a remote user. In step 112, the remote user may make a decision to accept, decline, or counter the offer. Step 114 may handle counteroffers, returning to step 102 for revalidation if revised terms are proposed. In step 116, the system may confirm offer acceptance, including verification of shipping and trade item commitments. Step 118 may generate shipping instructions and labels, and step 120 may monitor delivery and update shipment status. In step 122, the transaction may be completed with payment confirmation, commission settlement, and/or inventory locking. Finally, in step 124, post-transaction feedback may be collected from both parties. This flowchart may be understood to consolidate multiple interactions into the described steps, providing a high-level overview of asynchronous settlement, notifications, and trading processes without showing the detailed internal logic illustrated in, for example, FIGS. 3 and 4.

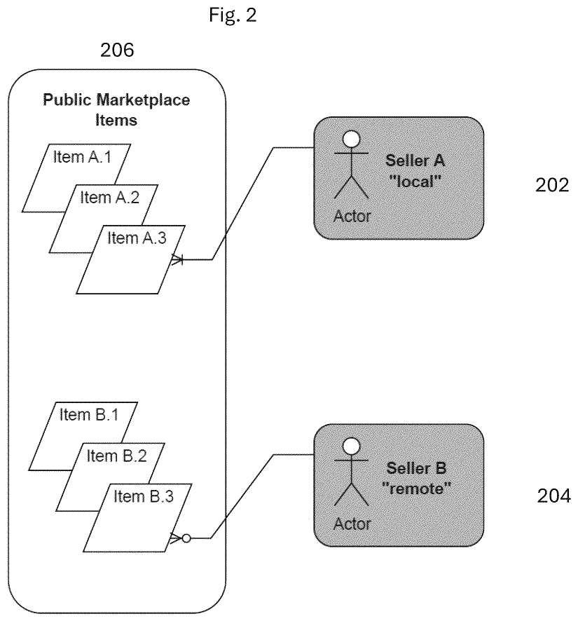

In one embodiment, as shown in FIG. 2, both parties may be existing sellers on a peer-to-peer e-commerce marketplace, with each party having active listed items for sale. In this example, the local user (“Seller A”) 202 may have items A.1, A.2, and A.3, while the remote user (“Seller B”) 204 may have items B.1, B.2, and B.3. All items may be displayed within a container 206 labeled “Public Marketplace Items.” As used herein, the terms “local seller,” “local user,” or simply “buyer” refer to a user that is the initiator of any offers, while the terms “remote seller,” “remote user,” or simply “seller” refer to a user that is the recipient of the original offer from the buyer. It should be appreciated that both the local user and the remote user have items for sale on the marketplace. Furthermore, as used herein, the term “the user” refers to both the local user and the remote user.

The system and method can facilitate settling transactions and bypassing conventional settlement. The model can include: 1) an order for the local seller to buy one or more of the remote seller's items; and 2) an optional trade order for the remote seller to buy one or more of the local seller's items. In exemplary embodiments, each involved user may be additionally associated with a PurchaseOfferFinancialSettlement domain object. Additionally, a PurchaseOfferItem concept may be introduced to keep track of item offer pricing to the end user versus the calculated commission basis price for the marketplace. When a foreign-key to one of these is present, orders may no longer be settled conventionally based on merchandise cost, tax and shipping because any trade credits in the corresponding trade order must be accounted for.

An example pseudo code list of what is directly stored or associated with a PurchaseOfferSettlement object may include uniqueId, associated offer identifier, offerInitiator identifiers, offer initiator ship to address identifier, offeree identifiers, offeree ship to address identifier, local order reference, trade order reference, financial data points for incoming payment, financial data points for outgoing settlement payments due, financial trade value debit and credit from associated order, financial charge & fees, commission/processing/tax, local order shipment cost, and trade order shipment cost. A pseudo code list of what is directly stored or associated with a PurchaseOfferListing object may include uniqueId, associated offer identifier, quantity sold, unit sale price, and unit commission basis unit price.

FIG. 3 shows a flowchart for an exemplary marketplace user interface node 302 illustrating creation and processing of a bundled and trade offer. The local user, referred to as Seller A 308, may initiate an offer for one or more items using the “Initiate an offer for Item” step 312. Upon initiation, Seller A 308 may make a decision to either continue with a conventional single-item offer purchase flow 316, consistent with typical e-commerce operations, or to add additional bundle items from a remote seller, Seller B 310, using the “Add more bundle items from Seller B” step 314. The Marketplace API 304 may be invoked to handle communication between the user interface node 302 and the data store 306 during these steps.

If Seller A 308 chooses to include additional items in the bundle, the system may present the option to add items as offers for trade 318, or to finish the order without trades 320. Once the decision is made, the system may create a trade offer 322, for example, Trade Offer #123.

All offer data, including selected bundle items and proposed trade items, may be stored in the data store 306 using the “Store Active Offer #123” step 324. The system may also retrieve updated offer data via “GET new offer data” 326 through the Marketplace API 304. Seller A 308 may then view the offer in the “View My Offers” interface 328, which displays the offer identifier 322, the included bundle items, and any proposed trade items. The remote user, Seller B 310, may then make a decision to decline 330, accept 332, or submit a counteroffer 334.

If Seller B 310 accepts the offer, the system may receive confirmation including verified shipping information through the “send acceptance with confirmed ship to info” step 336. Upon acceptance, the system may execute the “Confirm Offer #123 Actions” workflow 338, which may include updating the offer entity status, creating order and shipment entities for each seller, creating settlement transaction entities for each seller, and locking related inventory items while the transaction is pending. The Marketplace API 304 may coordinate these actions to ensure proper tracking and secure processing. This workflow ensures that the offer, bundle items, and trade items are properly tracked, that inventory may be reserved during processing, and that subsequent order fulfillment and financial settlement can be executed in a controlled and auditable manner.

FIG. 4 shows a flowchart for an exemplary marketplace user interface node, illustrating completion of a bundle and trade offer for the local user, Seller A 412, including checkout, payment, and payout for the transaction. While FIG. 4 illustrates actions of Seller A, a remote user, Seller B, may interact with the same system components and may follow an identical sequence of steps in the settlement process. The system components include the Marketplace User Interface Node 402, Marketplace API 404, Shipping Integration 406, Payment Gateway 408, and Payout Integration 410.

In the illustrated process, Seller A 412 may interact with the Marketplace User Interface Node 402 to view and respond to settlement requirements 420. The Marketplace API 404 may get available shipping rate data (422) from Shipping Integration 406, and Seller A 412 may decide whether to select shipping labels (424). The Marketplace API 404 may get pending offer settlement data (426), and Shipping Integration 406 may return rate data (428). Seller A 412 may confirm shipping rates (430), and the system may perform settlement with tax and fees calculations (432). Seller A 412 may decide to settle the balance (434), and the Marketplace API 404 may make payment through payment gateway integration (436), which may return an acknowledgment (438).

Following payment, the system may enter a wait state for task completion (440). A decision point (442) may determine whether to proceed with presenting shipping labels (444) or to enter a wait state (446) and/or show pending or owed payout (448). The Marketplace API 404 may execute a purchase label request (450) and get label information (452) from Shipping Integration 406. The system may enter a further wait state (454) until a second decision point (456) determines whether the item has been scanned at the carrier (458), which may involve Carrier Status Integration (460). Once confirmed, the Marketplace API 404 may direct Payout Integration 410 to issue the seller payout less commissions (462).

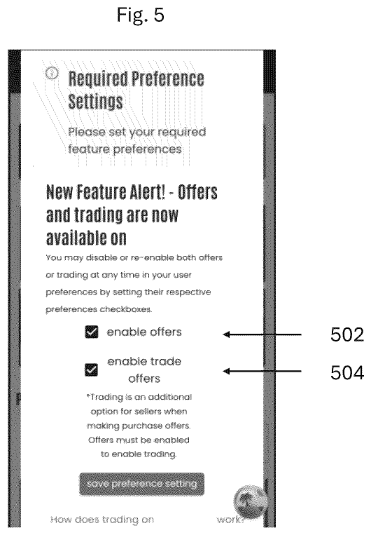

FIG. 5 illustrates an exemplary feature enablement interface 500 for a marketplace. The interface 500 may allow a user to enable or disable specific marketplace features, such as offers and trade offers. In one embodiment, the interface 500 may present two checkboxes labeled “Enable Offers” 502 and “Enable Trade Offer” 504. Selecting these checkboxes may enable the corresponding features, causing offer or offer-and-trade buttons to appear with listed items, allowing users to initiate customized offers. Upon selecting such a button, the user may be presented with a “make an offer” interface, which may include options to create a bundled offer, propose a trade, add shipping information, or message the seller. Creating a bundle may involve adding additional items from the same remote user, while proposing a trade may involve adding one or more of the local user's own listed items as trade-ins.

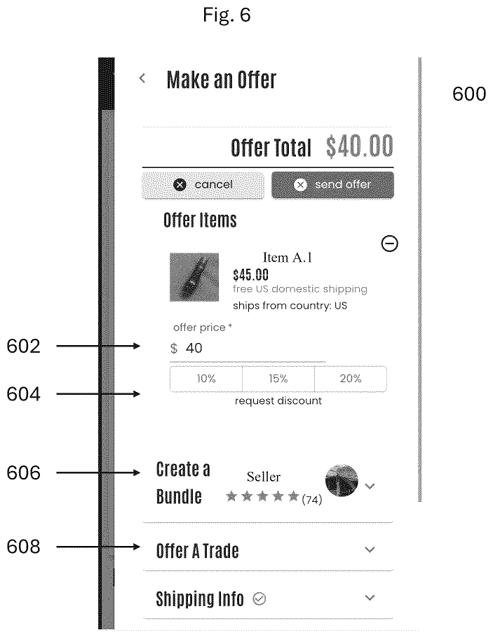

FIG. 6 illustrates an exemplary “make an offer” interface 600 for a marketplace. The interface 600 may present all selected items for a proposed bundle. Each item may include an editable offer price field 602. The interface 600 may also provide options to request a discount 604, such as 10%, 15%, or 20% for each item, respectively. Additionally, the interface 600 may include buttons to create a bundle 606 or offer a trade 608, allowing users to customize their proposed offer.

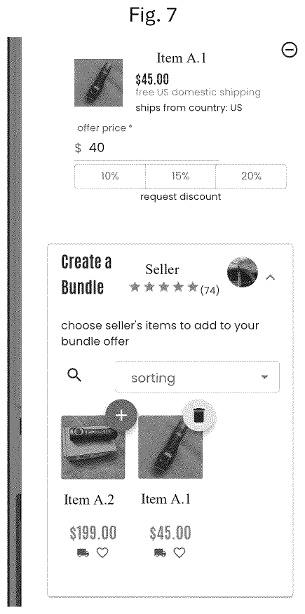

In one embodiment, a “create a bundle” interface may present the user with a searchable list of other items offered by the same remote user, as illustrated in FIG. 7. Items that are available may include an “add to offer” control, while items already added may show a “remove” option. Items not eligible for inclusion may appear in a disabled state. Once bundled items are added, the “make an offer” interface may display all selected items, each with editable offer price fields and quick-action buttons for applying standard discount percentages.

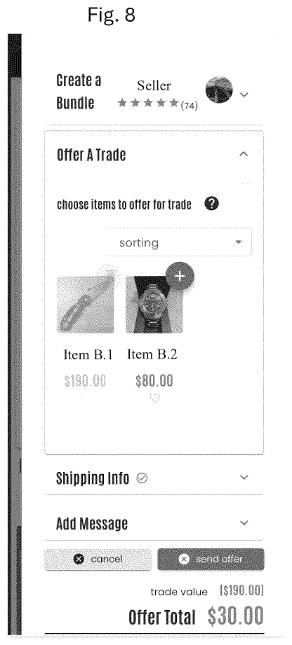

In one embodiment, an “offer a trade” interface may present a searchable list of the local user's own active listings, as illustrated in FIG. 8. Available items may be added using an “add trade item” control, and may appear in a mirrored layout relative to the items being purchased, visually representing the reciprocal nature of the trade. Each trade item may include editable pricing fields or adjustment sliders, allowing users to balance offer values. The total offer amount may be dynamically calculated to reflect credits or debits associated with trade items. When the user selects “send offer,” the system may store the pending offer on the server.

In one embodiment, when a seller receives a new offer from a buyer, a notification may be displayed both in-app and via email. Clicking the notification may navigate the seller directly to the “My Offers” interface, which is also accessible from a user menu.

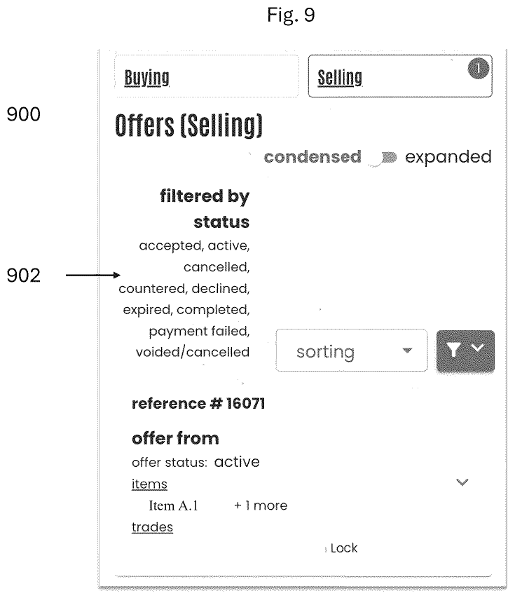

In one embodiment, the “My Offers” interface 900 may present two views: a condensed list and an expanded detail view, as illustrated in FIG. 9. In the condensed view, the user may view multiple offers, organized by status or by buyer/seller role, with separate tabs for offers where the user is the seller and offers where the user is the buyer. Offers may be filtered by status 902, such as “accepted,” “active,” “pending,” “cancelled,” “countered,” “declined,” “expired,” “completed,” “payment failed,” and “voided/cancelled.” Expanding a specific offer may reveal a full summary, including item details, offer terms, and available actions such as “accept,” “decline,” or “counter.” When an action is taken, corresponding notifications may be sent to the other user.

In one embodiment, accepting an offer may initiate a “complete offer” workflow for both users. Countering an offer may restart the negotiation loop, pre-populating involved items and allowing modified terms. Users may exchange counteroffers until one side accepts or declines, all through the same offer management interfaces.

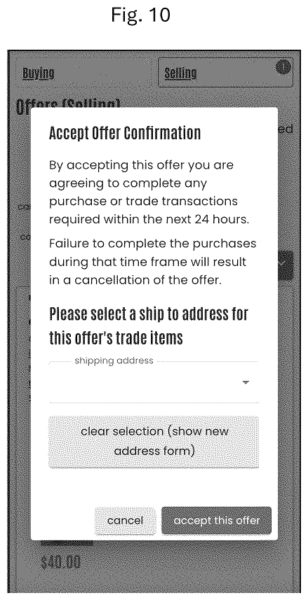

In one embodiment, an “accept offer confirmation” interface may prompt users to verify shipping addresses and delivery options before proceeding, as illustrated in FIG. 10. In trade transactions, both users may be required to ship items, and the interface may facilitate selection of appropriate shipping addresses for each side. Shipping options may include multiple carriers and service levels, and may include insured delivery where applicable. Once confirmed, the system may generate shipment and settlement instructions. After confirmation, users may select a “complete purchase” or “next steps” button, which redirects them to the offer checkout flow.

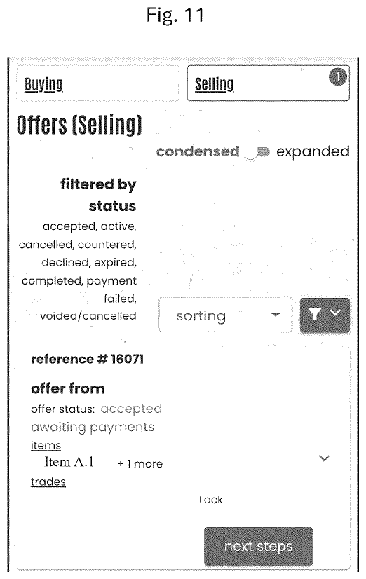

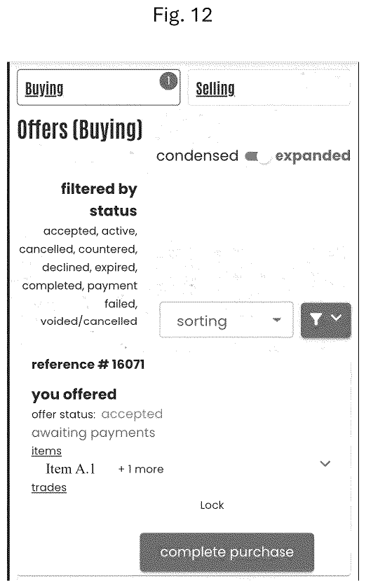

In one embodiment, following offer acceptance, the system may present both the seller and buyer with a “complete purchase” or “next steps” action button, as illustrated in FIGS. 11 and 12. The selection of these buttons may depend on whether the user is expected to provide payment, complete shipment tasks, or perform other remaining transaction steps. Each interface may display a stepwise checklist to guide the user through finalization, including verification of payment, shipping label selection, and order detail confirmation.

In one embodiment, an offer checkout interface may display task lists, offer summaries, and information about the counterpart user's progress. Depending on marketplace configuration, the system may assign one party to handle shipping label purchases, while the other may only confirm shipment readiness. If one party's steps remain incomplete, a “wait to ship” message may be shown until all requirements are satisfied. When ready, both users may print or download shipping labels, and the system may automatically synchronize shipment tracking information.

In one embodiment, once shipping details are finalized, a payment interface may appear to process applicable taxes, commissions, or fees. The user may complete the transaction through a standard payment gateway workflow using supported payment methods. Available payment options may include entering credit or debit card information, linking a bank account, or using third-party payment services such as Cash App Pay. The system may also offer a “Buy Now, Pay Later” option, such as Afterpay. Fees may be calculated dynamically based on confirmed shipping selections and offer values.

In one embodiment, a “user's tasks complete” view may indicate that the user has fulfilled all requirements and is awaiting the other party. Once both users have completed their respective tasks, an “all tasks complete” interface may appear, summarizing shipment tracking information, payment confirmation, and fulfillment status for each party.

In one embodiment, after completion of a transaction, the system may allow each user to provide feedback for the other party. For example, the buyer may rate the seller, and the seller may rate the buyer. Ratings may be provided on a scale of 1 to 5 stars, optionally with written comments. These ratings may be displayed in user profiles and used to inform future transactions or trust metrics within the marketplace.wati

In one embodiment, shipment notifications may be provided asynchronously. Users may receive both in-app and email alerts indicating when shipments are ready, in transit, or delivered. Notifications may integrate with the user's “Sales” and “Purchases” tabs for unified order tracking.

In one embodiment, sales listings and purchase listings may appear in standard marketplace workflows. For example, trade shipments from a buyer may appear in the “Sales” tab, while offer purchase shipments may appear in the “Purchases” tab. The interface may allow filtering by transaction type (sale, trade, or offer) and status (pending, shipped, completed).

In one embodiment, each order transaction may be treated as a sale order for commission purposes. The commission may be calculated based on item ownership and agreed offer prices. A commission-value-basis-price may be stored for each item to ensure accurate accounting, with minimum thresholds enforced relative to public listing prices. Commissions and processing fees may be automatically deducted or credited at settlement. Fraud prevention mechanisms may enforce minimum pricing thresholds and disallow offers on newly listed or recently repriced items.

To prevent lowball offers and users attempting to minimize commissions, a requirement may exist that items must spend a minimum amount of time on the public marketplace at the unitPrice involved in the offer when the offer is initiated. New items and items with recent price changes may not be eligible for offers and trades. Commissions may be based on a minimum percentage threshold of the publicly advertised price. Additionally, offer prices significantly below public market pricing may be prevented based on a fraud detection minimum percentage threshold.

Furthermore, the platform may offer seller protection to both parties by acting as the shipping insurer. Since the shipping label purchasing is integrated into the process, any insurance costs may become part of the shipping payment transactions.

The foregoing description and accompanying figures illustrate the principles, preferred embodiments and modes of operation of the invention. However, the invention should not be construed as being limited to the particular embodiments discussed above. Additional variations of the embodiments discussed above will be appreciated by those skilled in the art.

Therefore, the above-described embodiments should be regarded as illustrative rather than restrictive. Accordingly, it should be appreciated that variations to those embodiments can be made by those skilled in the art without departing from the scope of the invention as defined by the following claims.

What is claimed is:

1. A computer-implemented method for facilitating bundled multi-item purchase offers with user-to-user trading in a peer-to-peer e-commerce marketplace, the method comprising:
receiving, by a server, a selection of one or more items listed for sale by a first user account;
generating, by the server, a bundled purchase offer comprising the selected items and one or more additional items listed by the first user account;
receiving, by the server, one or more items offered for trade from a second user account in exchange for all or part of the bundled purchase offer;
calculating, by the server, a net transaction value based on the bundled purchase offer and the trade items;
storing, by the server, settlement data for the bundled purchase offer and trade items in a database;
presenting, via a user interface, the bundled purchase offer and trade items to the first user account for acceptance, rejection, or counteroffer; and
updating, by the server, the settlement data in response to acceptance, rejection, or counteroffer by the first user account.

2. The method of claim 1, further comprising sending at least one of in-app and email notifications to the first user account when the bundled purchase offer is created or modified.

3. The method of claim 1, further comprising generating shipping label information for the items included in the accepted bundled purchase offer and trade items.

4. The method of claim 1, wherein the calculating step further accounts for commission fees, transaction fees, and minimum offer price thresholds.

5. The method of claim 1, wherein the user interface enables the first user account to add additional items to the bundled offer.

6. The method of claim 1, wherein counteroffers are iteratively exchanged between the first and second user accounts until acceptance or rejection of the offer.

7. A computer system for facilitating bundled multi-item purchase offers with user-to-user trading in a peer-to-peer e-commerce marketplace, the system comprising:
a processor;
a memory storing instructions executable by the processor, the instructions, when executed, causing the system to:
receive a selection of one or more items listed for sale by a first user account;
generate a bundled purchase offer comprising the selected items and one or more additional items listed by the first user account;
receive one or more items offered for trade from a second user account in exchange for all or part of the bundled purchase offer;
calculate a net transaction value based on the bundled purchase offer and the trade items;
store settlement data for the bundled purchase offer and trade items in a database;
present the bundled purchase offer and trade items via a user interface for acceptance, rejection, or counteroffer by the first user account; and
update the settlement data in response to acceptance, rejection, or counteroffer by the first user account.

8. The system of claim 7, wherein the instructions further cause the system to send at least one of in-app and email notifications when the bundled purchase offer is created or modified.

9. The system of claim 7, wherein the instructions further cause the system to generate shipping label information for items included in an accepted bundled purchase offer and trade items.

10. The system of claim 7, wherein the calculation of net transaction value accounts for commission fees, transaction fees, and minimum offer price thresholds.

11. The system of claim 7, wherein the user interface allows iterative counteroffer exchanges between the first and second user accounts until acceptance or rejection.

12. The system of claim 7, wherein the memory stores a PurchaseOfferFinancialSettlement object and a PurchaseOfferItem object to track offer pricing, trade values, and settlement data.
